(19) United States
(12) Patent Application Publication
(10) Pub. No.: US 2025/0375051 A1
(43) Pub. Date: Dec. 11, 2025

(54) DRINKING SYSTEM

(71) Applicant: August Töpfer & Co. (GmbH & Co.) KG, Hamburg (DE)

(72) Inventor: Rudolf Ernst, Hamburg (DE)

(21) Appl. No.: 18/844,519

(22) PCT Filed: Feb. 10, 2023
(86) PCT No.: PCT/EP2023/053361

§ 371 Date: Sep. 6, 2024

(30) Foreign Application Priority Data
Mar. 11, 2022 (DE) 10 2022 105 794.1

(51) Int. Cl. A47G 19/12; A23L 2/56; A23L 2/60; A47G 19/22; B01F 23/40; B01F 23/451; B01F 25/316; B01F 35/71; B01F 101/14; B65D 47/06; B65D 51/16; B65D 51/28

(52) U.S. Cl. CPC A47G 19/12; A23L 2/56; A23L 2/60; A47G 19/2222; A47G 19/2272; B01F 23/451; B01F 23/48; B01F 25/316; B01F 35/718; B65D 47/06; B65D 51/1672; B65D 51/28; A47G 2019/122; A47G 2019/125; B01F 2101/14; B01F 2215/0431; B01F 2215/044; B65D 2217/02

(57) ABSTRACT

Disclosed is a drinking system (1) with
a drinking vessel (2) defining a receiving chamber (3) for a liquid,
a drinking straw (4) arranged on the drinking vessel (2), projecting from the drinking vessel (2) and guided into the receiving chamber (3), with a first end having an inlet opening (5) which projects towards a base of the receiving chamber (3), and with a second end having a drinking opening (6), and with a suction channel (7) between the inlet opening (5) and the drinking opening (6), and
an aroma reservoir (8) connected with the drinking straw (4) via an inflow channel (9).

According to the invention, the drinking system is characterized in that the aroma reservoir (8) contains a liquid aroma medium which contains fragrances and/or flavorings in dissolved or emulsified and thus diluted form and which, when liquid is sucked from the drinking vessel (2) through the drinking straw (4), is sucked through the inflow channel (9) into the drinking straw (4) and is mixed there with the liquid sucked into the drinking straw (4) from the drinking vessel (3).

The present invention relates to a drinking system having the features of the preamble of claim 1.

Drinking systems are described in the prior art which allow the consumption of water mixed with fragrances introduced into the air, such that the water seems to have a taste different from the taste of pure water due to the sensory phenomenon known as retronasal olfaction, whereby fragrances carried in the air via the mouth and throat are perceived by the sense of smell but interpreted by the brain as taste. Depending on the choice of fragrance, the drinking water seems, for example, to taste of orange, peppermint or similar, although the substance consumed as a drink is still pure drinking water.

Such a drinking system is disclosed, for example, in WO 2019/016096 A1. A drinking system developed by the inventors named in that laid-open document and based on the principles disclosed therein is available on the market under the brand name Air Up®.

A component of this drinking system is a drinking container in the form of a drinking bottle into which, starting from a drinking opening at an upper end, a drinking straw projects down to or close to a base located at a lower end of the vessel. In a section located close to the drinking opening, an opening with a smaller diameter than a cross-section of the drinking straw is provided in an outer wall of the drinking straw. Another component of the drinking system is a fragrance reservoir that can be placed on or attached to the drinking container and has an inflow opening and an outflow opening. The fragrance reservoir is loaded with a fragrance that is released into the air flowing through the fragrance reservoir from the inflow opening to the outflow opening. When the fragrance reservoir is arranged on the drinking vessel, the outflow opening is fluidically connected to the opening in the outer wall of the drinking straw. When a user of the drinking system sucks on the drinking straw, thereby triggering a flow of beverage contained in the drinking vessel, namely water, a negative pressure is created at the opening in the outer wall of the drinking straw through which air is sucked in via the fragrance reservoir, the air being loaded with fragrance as it flows through the fragrance reservoir and then reaching the user's mouth and throat together with the sucked-in water where it produces the aforementioned sensory effect through retronasal olfaction, and thus the desired impression of taste which is determined by the type of fragrance.

The system known from the prior art works in that the user generates a negative pressure in the drinking straw and sucks in air, together with the liquid to be drunk, via the inflow opening, which is provided with a fragrance, i.e. is fragranced, in the fragrance reservoir. In the prior art, this is performed in that the air in the fragrance reservoir is guided over a fragranced storage medium. The sucked-in air absorbs fragrance from the storage medium when passing by. The fragrance reservoir is designated as “aroma unit” in the application DE 20 2016 004 961 U1 2016 Oct. 20 and is currently sold on the market as “fragrance pod” for use in the above-stated drinking system which is offered under the trademark Air Up®. This known system has the following disadvantages:
The fragrance release of such fragrance pods is not constant over the use amount, in practice a use amount of five liters of beverage is mentioned, but decreases continuously over the period of use of the fragrance pod. This is due to the fact that the concentration of the fragrances in the storage medium decreases with increasing duration of use. This means that the diffusion pressure of the fragrances decreases over the duration of use, so that the passing air is fragranced less and less. The taste experience or the intensity of the taste caused by retronasal olfaction decreases with a regressive course that fades out asymptotically towards the zero line. Thus, the user is faced with the question of when exactly the fragrance pod is exhausted and has to be replaced. However, this question cannot be answered easily and clearly since the reduction of the olfactory experience per part of volume drunk becomes smaller and smaller. It would be better if the olfactory experience ended abruptly rather than gradually, so that the user can clearly recognize when the exhausted fragrance pod needs to be replaced. The user is faced with the dilemma of either replacing the fragrance pod too early and potentially forego the use they have paid for or waiting too long and accepting a limited taste experience, which is not desired. Due to the regressive character of the exhaustion of the fragrance pod, the change in the olfactory experience towards the end of the intended amount of use is only slight per volume unit of liquid drunk, so that the exhaustion of the fragrance pod is difficult to estimate. Some users deal with this by keeping a tally of the liquid consumed with one fragrance pod so as to be able to determine the time of exhaustion of a fragrance pod more precisely via a quantity of consumed liquid. This is, of course, a cumbersome solution.
The amount of air that can be sucked into the drinking straw without impairing the drinking experience too much by the formation of bubbles-which results in a drinking sensation described as “bubbly” by users-is limited to a maximum of 20 to 30% of the volume flow. Therefore, the amount of fragrance that can be guided into the mouth of the drinking person with such a system is also limited, of course. This limitation is due to the amount of fragrance that can be absorbed by the given air flow. This fact limits the taste experience that can be created. In the known drinking system of the Air UP® trademark, a maximum of 0.3 grams of fragrance are used per 5 liters of water upon maximum absorption of the fragrances stored in the fragrance pod. On average, this corresponds to a proportion of 0.006% with respect to the mass flow of liquid to be drunk. This results in a mixing ratio between drinking liquid and fragrance of more than 1 to 15,000, which is quite an extreme value. With these extreme dilution of the fragrance in the liquid-air mix to be drunk, the taste experience can exclusively be achieved via retronasal olfaction or tasting. A conventional taste experience generated on the tongue cannot be provided by this system due to a concentration of the aroma substances that is too low. Thus, it is also impossible to taste sweetness since the receptors for sweetness are located exclusively on the tongue and thus this flavor cannot be perceived via retronasal olfaction. This is a disadvantage since a certain amount of sweetness is part of a balanced taste experience for many people.
The use of plastic is unnecessarily high in relation to one liter of drunk liquid. One fragrance pod is supposed to be sufficient for five liters of beverage and weighs approximately 7.5 grams. Around 3 grams thereof are attributed to the storage medium for the fragrance, 0.3 grams to the fragrance and the remaining 3.2 grams to the plastic packaging. This means that only 4% of proportionate weight of the fragrance pod constitute fragrance; 96% are packaging.
Moreover, each fragrance pod has to be individually packaged in very elaborate manner in aroma-tight barrier films to ensure that no fragrance is lost in the period between production and use. The ratio of effective fragrance to packaging is very unfavorable, namely almost 1:1. This means that one fragrance pod weighing 7.5 grams is shrink-wrapped in plastic packaging with a total weight of 6.4 grams. In total, there are 13.6 grams of packaging material (including the storage medium) for 0.3 grams of fragrance, i.e. a ratio of 45:1.
In the solution of the Air Up® drinking system, some kind of switch-off mechanism is provided. The screw cap displaces the fragrance pod relative to a rubber element. Thus, the openings for supply and exhaust air are covered and provisionally closed. In view of the high diffusion pressure inherent to concentrated fragrances in relation to the ambient air, this measure significantly reduces the ageing of the product when not in use, but does not completely prevent it.

Moreover, systems are known from the prior art, e.g. from US 2010/0012193 A1 or US 2015/0307265 A1, which provide regular drinking water with taste by guiding it past a solid body during the drinking process. This solid body consists of pressed, water-soluble aromas and flavorings, which dissolve in the liquid to be drunk. These systems can also impart a conventional taste experience. However, the advantageous effect of retronasal olfaction and tasting is not or only marginally utilized in these systems.

The present invention has set itself the object of developing a drinking system that makes use of both the principle of retronasal olfaction and the principle of conventional tasting by also targeting the taste receptors on the tongue. Moreover, the disadvantages of the known products are to be overcome.

A drinking system according to the invention has the following components:
a drinking vessel defining a receiving chamber for a liquid,.
a drinking straw arranged on the drinking vessel, projecting from the drinking vessel and guided into the receiving chamber, with a first end having an inlet opening which projects towards a base of the receiving chamber, and with a second end having a drinking opening, and with a suction channel between the inlet opening and the drinking opening,
an aroma reservoir connected with the drinking straw via an inflow channel.

To this extent, the drinking system according to the invention still corresponds to a drinking system known from the prior art. However, it differs therefrom and is characterized in that the aroma reservoir contains a liquid aroma medium which contains fragrances and/or flavorings in dissolved or emulsified and thus diluted form and which, when liquid is sucked from the drinking vessel through the drinking straw, is sucked through the inflow channel into the drinking straw and is mixed there with the liquid sucked into the drinking straw from the drinking vessel.

The invention is based on the idea of using the negative pressure in the drinking straw to suck a liquid aroma medium into the liquid to be drunk rather than air loaded with fragrance. Fragrances and/or flavorings are either dissolved or emulsified in this liquid aroma medium. The fragrances or flavorings can consist of essential plant oils, such as lime oil.

Furthermore, the invention provides that these fragrances and/or flavorings are used in diluted form. One reason for using them in diluted form is that concentrated fragrances in their undiluted pure form are not suitable for human consumption in many cases, since they can cause irritation to mucous membranes. On the other hand, the diluted form is also chosen since, due to the dilution, a larger amount of the liquid aroma medium has to be conveyed, resulting in a larger volume flow. A larger volume flow is more constant and is therefore less sensitive to influences caused, for example, by manufacturing tolerances of the components, such as the diameter of bores and roughness on the inside of a supply channel. Temperature-related fluctuations in the viscosity of the liquid aroma medium to be conveyed also have less of an effect in diluted form.

If the fragrances and/or flavorings are water-soluble substances, they can be diluted with water, i.e. the liquid aroma medium can be a solution of the fragrances and/or flavorings in water. However, if the fragrances and/or flavorings are water-insoluble substances, such as essential oils, the invention provides the use of an emulsifier as a facilitator for dissolving the respective substances in water. In this event, the liquid aroma medium is an emulsion in water. Suitable emulsifiers for essential oils are polysorbate or lecithin, for example.

The dilution according to the invention of the fragrances or flavorings filled in the aroma reservoir is to be regarded as a premix, so that the process of mixing these substances with the water to be drunk can be regarded as a two-step process. The two-step mixing process is much more efficient than a single-step mixing process and enables particularly homogeneous mixing, even with high mixing ratios.

For example, a ratio of 1:15 to 1:1,000 can be selected for the dilution of fragrances or flavorings in the liquid aroma medium.

By designing the drinking system accordingly, in particular the tube diameters and opening radii of the drinking straw, inflow channel and other flow elements involved, a further dilution of the liquid aroma medium sucked from the aroma reservoir with the liquid to be drunk can be achieved in the drinking straw at a ratio of e.g. 1:10 to 1:1,000.

By combining both mixing processes, the mixing ratio of fragrance or flavoring in the liquid to be drunk can vary from 1:150 to 1:1,000,000.

The extreme value of a dilution of the aroma substances in the liquid to be drunk at a ratio of 1:1,000,000 will be of no practical significance since such a low concentration will be too low to achieve a satisfactory taste or retronasal olfactory experience.

This is only considered here to illustrate the variability and efficiency of the two-step mixing process.

With a dilution factor of 1:1,000,000, the dilution in this variant would be 62 times higher than the dilution factor of the AirUp product, which is around 1:16,000.

The two-step mixing process makes it possible in particular to dissolve sweeteners in the aroma medium as well and then distribute this homogeneously in the liquid to be drunk during the drinking process.

Compared to sugar, modern sweeteners such as stevia or aspartame have a very high sweetening power, around 400 to 500 times more intense than sugar. The sweetening power of acesulfame is slightly lower, but still 200 times more intense than sugar. The high sweetening power of modern sweeteners requires considerable dilution and even distribution in the liquid to be drunk, namely
1:4,000 to 1:50,000 for stevia and aspartame, or.
1:2,000 to 1:10,000 for acesulfame.

Said sweeteners can be combined with each other to exploit synergistic effects.

In any case, the range of expedient mixing ratios is within the range that is technically possible according to the invention.

In an advantageous further development, the invention provides that the liquid aroma medium to be sucked is stored in a container which has a small height in relation to its base area; for example, a height of 15 mm in relation to a base area of 900 to 1,000 square millimeters, which corresponds to a ratio of approximately 1:60.

Furthermore, the invention provides that the height of this container can advantageously be very small in relation to the length of the drinking straw, namely around 15 to 20 mm. This corresponds to about 10% of the length of a drinking straw that is typically used in a drinking system according to the invention.

As a result of this design, changes in the static pressure in the container in which the liquid aroma medium to be sucked is held are very small due to consumption, so that the amount of aroma medium sucked into the liquid to be drunk hardly fluctuates or does not fluctuate at all.

According to a further development of the invention, it may be provided that the container in which the liquid aroma medium to be sucked is held is provided with a supply air opening. According to the invention, this opening can advantageously have a relatively small diameter, preferably 1 mm or less, so as to act as a throttle and limit the amount of liquid aroma medium sucked into the drinking straw.

In particular, the container can be arranged in such a way that this supply air opening can be closed with a lid, e.g. a screw cap, which also closes the drinking bottle or drinking straw when not in use.

In particular, the container with the liquid aroma medium can be provided with a removable lid which allows the container to be refilled and also cleaned so that it can be used several times. The lid can be secured to the container by an external thread on the outer circumference, which engages in an internal thread on the inner wall of the container. The inner edge of the screw cap can be sealed in particular by a sealing surface. This sealing surface can be provided with an O-ring made of a flexible material to improve the seal.

The container containing the liquid aroma medium to be sucked can advantageously be designed with an annular base and can be arranged concentrically around the drinking straw. In this case, a removable lid of the container, which allows cleaning and refilling, can be designed in an annular shape. However, other container geometries are also conceivable.

With an annular cylindrical design of the container for the liquid aroma medium to be sucked, the following dimensions of the container result: inner diameter 20 mm (opening), outer diameter 40 mm, height 15 mm, a filling volume of around 14 ml.

With a mixing ratio of 1:1,500 between the liquid aroma medium to be sucked and the liquid to be drunk, which corresponds to 10 times the aromatization obtained with the Air Up® drinking system known from prior art, these 14 ml are sufficient for around 20 liters of liquid. This shows how efficient the approach according to the present invention is compared to the prior art. According to the invention, four times the yield can be achieved with a 10 times better taste experience.

For refilling into the container, the liquid aroma medium can be offered either in a bottle made of glass or plastic or in bags with a screw cap, which results in a considerable reduction in the use of plastic in relation to one liter of liquid to be drunk.

Moreover, in a possible further development, the invention provides that the aroma reservoir is arranged and designed in such a way that the liquid aroma medium held there cannot enter the drinking straw by the action of gravity when not in use.

This can be done expediently in that the connection to the drinking straw in the form of a tube, which dips into the liquid aroma medium, leads upwards so that the negative pressure in the drinking straw has to overcome the effect of gravity on the liquid column of the liquid aroma medium.

The diameter of the tube leading from the aroma reservoir to the drinking straw is preferably chosen to be relatively small as well. Tests have shown that diameters of 1 mm are sufficient here.

The small diameter of this supply tube, in combination with the closure of the supply air opening, prevents the container from emptying into the drinking straw when the bottle is closed. Since the conveying effect of the negative pressure in the drinking straw is very good, the surface of the supply tube can be designed to be rough if necessary to increase the leakage safety when not in use. Here, the surface of the supply tube can have an average roughness value Ra according to DIN EN ISO 4287:2010 of 0.8 to 3.2 μm.

In contrast to the functionality of the known products, the user clearly recognizes that the container with the liquid aroma medium has to be refilled or is exhausted when the level has dropped so much that, firstly, a considerable amount of air is sucked into the drinking straw and, secondly, the taste experience is suddenly absent. If the container is designed to be transparent and can be viewed from the outside of the drinking system, the user can even visually assess the fill level.

The mixing ratio that results during use between the aroma medium to be sucked and the liquid to be drunk can be advantageously influenced by the design of the drinking straw. If the amount of aroma medium to be sucked is to be increased, a narrowing can be provided in the drinking straw, which generates dynamic negative pressure. This narrowing can advantageously be designed as an injector pump. This solution is particularly suitable if a highly viscous aroma medium is to be sucked.

If the amount of liquid aroma medium sucked into the drinking straw is greater than desired because the static negative pressure acting in the drinking straw is too strong, the drinking straw can be widened at the inflow point to create dynamic overpressure in the drinking liquid, which counteracts the static negative pressure. In initial tests, this variant has turned out to be significant for practical implementation.

Drinking a liquid that is provided with flavorings or aroma substances generates a retronasal taste experience in that aromas partially evaporate from the liquid in the mouth and throat and rise through the throat into the nose, reaching the taste receptors located there. The evaporation of these aroma substances in the throat is facilitated by turbulence that occurs in the liquid during drinking, as well as by the warming of the liquid to be drunk in the mouth and throat.

According to the invention, in a further development, the retronasal taste experience can be intensified by sucking air into the liquid to be drunk. In contrast to the prior art, however, this air is not fragranced and is not used to introduce fragrances or aromas into the resulting mixture of liquid to be drunk and sucked air. Foregoing this function makes it possible to significantly limit the air flow to be sucked, namely to a fraction of the air sucked according to the prior art. A volume flow of between 5 and 10% of the volume flow of the liquid to be drunk is advantageous. Thus, the “bubbling effect” observed in the prior art is avoided.

The air can be sucked either after the liquid to be drunk has been mixed with the liquid aroma medium or before.

This has the advantage that the sucked air can be mixed intensively with the liquid to be drunk. This can be done, for example, using mixing arrangements such as those described in the still unpublished patent application DE 10 2021 129 285.9, in particular conically designed mixing chambers whose mixing effect is based on turbulence generated in the liquid to be drunk by the separation of the laminar flow in the conical mixing chamber. This solution is technically very simple and inexpensive to implement.

If a more intensive mixing effect is desired, helical mixing inserts can be inserted into the drinking straw, as also described in the above-stated patent application.

During the mixing process, the air bubbles that have formed in the liquid to be drunk absorb the aromas or fragrances in the drinking straw that have been sucked into the liquid to be drunk as a premix.

These air bubbles separate in the throat due to their low density compared to the liquid, rise upwards in the oral cavity and collapse. The aromas and fragrances, which have previously been absorbed from the liquid into the air bubbles, rise through the throat into the nose and reach the receptors located there so that the taste experience is intensified by retronasal olfaction. In addition, the escaping air bubbles continue to extract aroma substances from the liquid in the mouth, which further intensifies the taste experience.

Further advantages and features of a drinking system according to the invention are apparent from the following description of possible embodiments on the basis of the attached figures. The figures show the following:

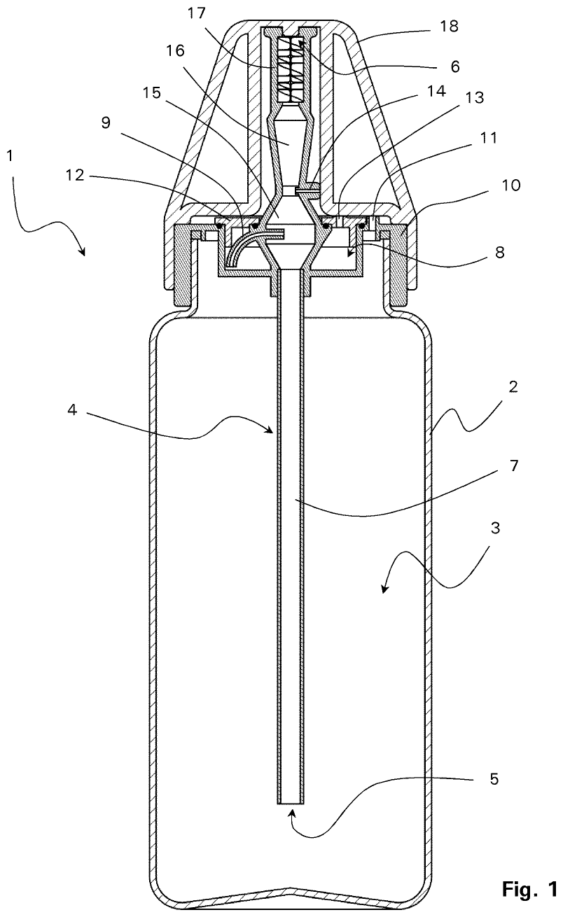

FIG. 1 shows a schematic representation of a possible embodiment of a drinking system according to the invention in a longitudinal sectional view;

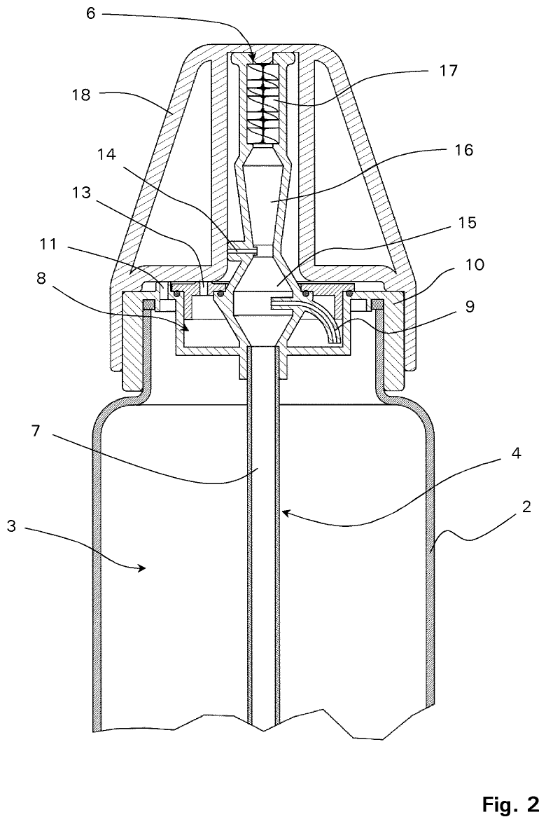

FIG. 2 shows an enlarged illustration of a partial view of the drinking system of FIG. 1 in longitudinal section, but in the opposite viewing direction;

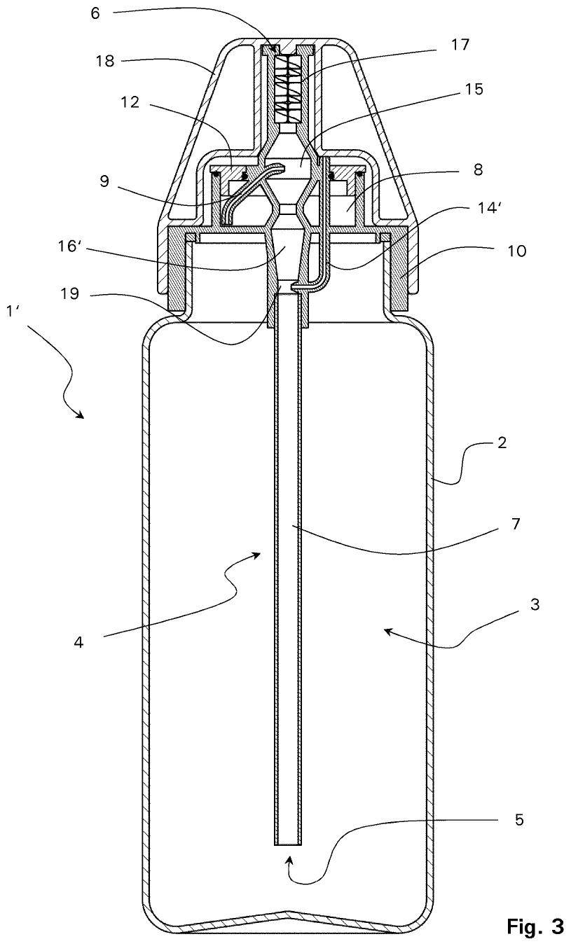

FIG. 3 shows a schematic illustration of a drinking system according to the invention in a second possible embodiment in a longitudinal sectional view; and

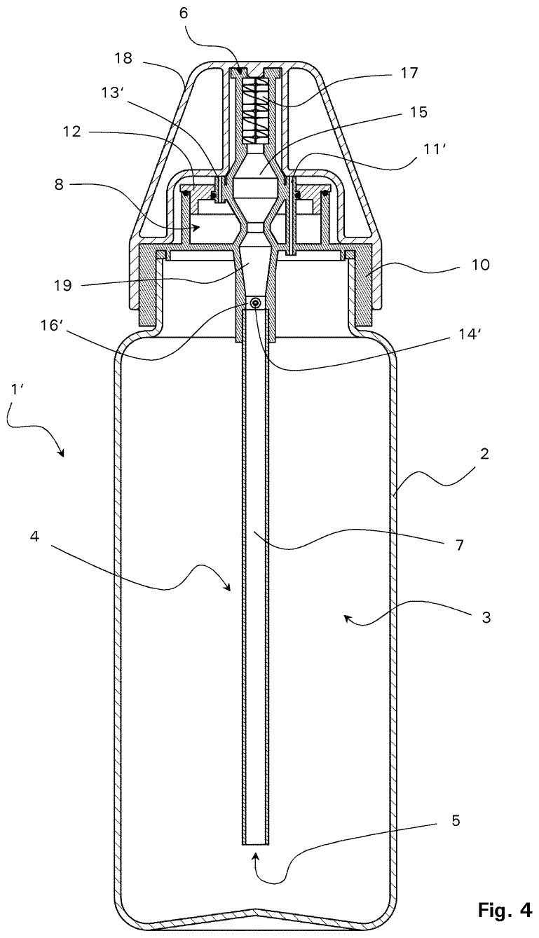

FIG. 4 shows a schematic illustration of the drinking system of FIG. 3 in a longitudinal sectional view rotated by 90° compared to the illustration in FIG. 2.

In the figures, possible embodiments of a drinking system according to the invention are shown in schematic illustrations. The figures are not necessarily completely true to detail and scale. Rather, they serve to illustrate the features and components essential to the invention and other features and components advantageous to the invention and, together with the following description, serve to further illustrate the principle according to the invention.

First of all, FIGS. 1 and 2 show a drinking system 1 according to a first possible embodiment of the invention. Said drinking system 1 comprises a drinking vessel 2, which in this case is shaped like a bottle. The drinking vessel 2 defines a receiving chamber 3 formed therein, into which a liquid to be consumed, in particular drinking water, can be filled. Another component of the drinking system 1 is a drinking straw 4 which protrudes into the receiving chamber 3. The drinking straw 4 has an inlet opening 5 at one end pointing towards the base of the drinking vessel 2. A drinking opening 6 is provided at an opposite end. A suction channel 7 is formed between the inlet opening 5 and the drinking opening 6.

A further component of the drinking system 1 is an aroma reservoir 8, into which a liquid aroma medium containing fragrances and/or flavorings in dissolved or emulsified and thus diluted form can be filled and is filled for use of the drinking system 1 (not shown here). An inflow channel 9 protrudes into the aroma reservoir 8, in this case in the form of a curved suction tube leading to the base of the aroma reservoir 8, where it is open. The inflow channel 9 is connected to the drinking straw 4 and opens into the suction channel 7. The drinking vessel 2 is closed at the top with a cover 10 which can be detached from the drinking vessel 2 so that a drinking liquid can be filled into the receiving chamber 3 when the cover 10 is removed. An opening 11 is provided in the cover 10, through which air can flow into the receiving chamber 3 when liquid is sucked out of the receiving chamber 3 through the drinking straw 4. The receiving reservoir 8 contains a trough section which is integrally formed in the cover 10 and which can be closed with a lid 12. The lid 12 can be detachably fixed to the trough section and can be removed in order to add or refill liquid aroma medium into the aroma reservoir 8. An opening 13 is formed in the lid 12, which—similar to the opening 11—allows air to flow into the interior of the aroma reservoir 8. The openings 11 and 13 can be provided with valve elements, for example formed by sealing lips, which allow air to flow in if a negative pressure occurs in the receiving chamber 3 or in the aroma reservoir 8, but prevent liquid content from escaping from the receiving chamber 3 or the aroma reservoir 8 through the openings 11 or 13.

Furthermore, an air channel 14 can be seen, which leads into the suction channel 7 in the manner of a branch line which has a significantly reduced diameter compared to the suction channel 7 and through which air can be sucked into the suction channel 7.

The inflow channel 9 opens into the suction channel 7 in a section 15. In section 15, a widening is formed by a conically shaped expansion of the diameter of the suction channel 7, wherein the inflow channel 9 opens into the suction channel 7 in the portion with the maximum diameter. Adjacent to this opening area, a conical taper is formed, in which the suction channel 7 tapers in section 15 to a minimum diameter that forms a nozzle-like passage. Said section 15 forms a mixing chamber in which, when drinking liquid located in the receiving chamber 3 is sucked in by suction at the drinking opening 6 of the drinking straw 4, the drinking liquid is mixed with a liquid aroma medium sucked in from the aroma reservoir 8 via the operating principle of a water jet pump. The air channel 14 opens into the portion with the smallest diameter that forms a kind of nozzle opening in the suction channel 7, through which air channel air is sucked in and enters the liquid-also due to a negative pressure formed by the drinking liquid flowing past here during suction. In a section 16, a further mixing chamber is formed with an axially elongated conical widening and a subsequent axially shorter conical taper, in which the sucked air is mixed with the drinking liquid previously mixed with the aroma medium received in section 15. Thus, very fine air bubbles are formed, in which the aroma medium can form gaseous components or in which it can form fine aerosols. In a further section 17 adjoining section 16, spiral-shaped guide structures are provided in the suction channel 7, which once again cause a further thorough mixing of the drinking liquid with the absorbed aroma medium and the supplied air.

FIGS. 1 and 2 show a closing lid 18 placed on the drinking system 1, which is configured to close the drinking opening 6 of the drinking straw 4 and also covers the openings 11 and 13 so as to prevent accidental leakage of liquid from the receiving chamber 3 and/or from the aroma reservoir 8. To use the drinking system 1, said closing lid 18 is removed and the user sucks at the drinking opening 6 of the drinking straw 4 so as to suck in drinking liquid, in particular drinking water, located in the receiving chamber 3 through the inlet opening 5 into the suction channel 7 of the drinking straw 4, as already explained above. In the manner already described above, the drinking liquid is subsequently mixed or provided with the liquid aroma medium in section 15, and this mixture is subsequently supplied with air sucked from outside, then this mixture is further mixed in section 16 and once again in section 17.

When the liquid provided with aroma medium and air and thoroughly mixed subsequently exits the drinking straw 4 at the drinking opening 6 and reaches the mouth and throat of the user, the dissolved air bubbles out and transports gaseous or aerosolized aroma components towards the back of the throat, where the user then experiences a so-called retronasal olfactory experience. Thus, a taste experience is suggested to the user so that a tasteless beverage consumed from the drinking system 1, for example plain tap water, seems to taste like citrus fruit, strawberries or raspberries, for example, depending on the aroma substance chosen in the aroma medium. This taste experience can be enhanced even more to further emulate the natural taste if the aroma medium contains a liquid-soluble sweetener so that the user also feels a taste sensation on the tongue together with the retronasal olfactory experience. The reason for this is that “sweet” cannot be perceived as a flavor via retronasal olfaction. The corresponding receptors are located exclusively on the tongue.

By an appropriate choice of the diameter ratios of the inflow channel 9, suction channel 7 and the widenings and tapering formed in sections 15 and 16 as well as the diameter of the air channel 14, a mixing ratio of liquid to be drunk with liquid aroma medium and introduced air can be achieved in typical use, i.e. a typical negative pressure applied by the user during suction, which allows an optimal taste experience to be obtained in terms of intensity. In particular, not too much of the aroma medium is carried along, but also not too little, so that the taste experience caused by retronasal olfaction is not too weak. The liquid aroma medium is already formed by a diluted aroma substance, such as an essential oil, in order to prevent an overdose, which could otherwise lead to unpleasant consequences, for example a burning and stinging sensation in the mouth and throat of the user, who receives too high a dose of aroma medium.

FIGS. 3 and 4 illustrate a second possible embodiment example of a drinking system 1′ according to the invention. In this embodiment example, most of the components and features of the drinking system 1′ are also constructed in the same way as in the drinking system 1, as shown in FIGS. 1 and 2. Identical elements, or at least elements with the same effect, are designated by reference numbers identical to those in FIGS. 1 and 2. With regard to the structure and function of the identically designated parts and elements, reference can be made to the above description of the embodiment example according to FIGS. 1 and 2 and the structure and function of the identically designated elements therein in order to avoid repetition.

The essential difference between the alternative embodiment example shown in FIGS. 3 and 4 compared to the variant shown in FIGS. 1 and 2 is the reversed order of the supply of air and aroma medium, which is achieved by a different arrangement of mixing chambers, into the flow of liquid to be drunk flowing through the drinking straw 4, or more precisely through the suction channel 7. In the embodiment examples shown in FIGS. 3 and 4, the supply of air is initially realized in a section 16′ through an air channel 14′. The air channel 14′ opens into a narrowing 19 of the suction channel 7, wherein this narrowing 19 creates a water jet pump effect that sucks air through the air channel 14′ as the drinking liquid flows past. In this embodiment example, the air sucked into the drinking liquid as first additional medium is mixed with the drinking liquid in a mixing chamber formed in section 16′ that is formed in analogy to the mixing chamber in section 16 of the suction channel 7 in the embodiment example shown in FIGS. 1 and 2. Only thereafter, the drinking liquid already loaded with air enters section 15 in which aroma medium sucked from the aroma reservoir 8 via the inflow channel 9 is received in the drinking liquid, as shown in the embodiment example illustrated in FIGS. 1 and 2, and said aroma medium is mixed with the drinking liquid formed in the mixing chamber formed in section 16. Subsequently, final mixing takes place in section 17 of the suction channel 7 provided with spiral-shaped structures, just as in the embodiment example described above and shown in FIGS. 1 and 2.

A further difference is that instead of the openings 11 and 13, as formed in the embodiment examples shown in FIGS. 1 and 2 and described above for supplying air into the receiving chamber 3, or into the aroma reservoir 8, downstream flow tubes 11′ and 13′ are provided here, which serve the same purpose.

Otherwise, the embodiment example shown in FIGS. 3 and 4 works and functions in the same way as the embodiment example shown in FIGS. 1 and 2 and described above with regard to the drinking experience they create, so that reference can also be made to the above description in this respect.

The two possible arrangements for the admixture or addition of air and aroma medium shown in the illustrated embodiments, in the sequence of aroma medium first, then air (FIGS. 1 and 2), or air first and then aroma medium (FIGS. 3 and 4), are essentially technically equivalent and can be chosen and provided as required.

The shown embodiment examples are to serve as explanation and do not restrict the scope of the claimed invention to a combination of the feature combinations shown and specifically described. The invention in its general scope is defined in the following claims. In particular, individual features of the embodiment examples described can also, in isolation from the specific design described in the context, bring about an independent improvement of the invention individually.

### LIST OF REFERENCE NUMBERS

1 Drinking system
1′ Drinking system
2 Drinking vessel
3 Receiving chamber
4 Drinking straw
5 Inlet opening
6 Drinking opening
7 Suction channel
8 Aroma reservoir
9 Inflow channel
10 Cover
11 Opening
11′ Downstream flow tube
12 Lid
13 Opening
13′ Downstream flow tube
14 Air channel
14′ Air channel
15 Section
16 Section
16′ Section
17 Section
18 Closing lid
19 Narrowing

1. A drinking system with comprising:
a drinking vessel defining a receiving chamber for a liquid,
a drinking straw arranged on the drinking vessel, projecting from the drinking vessel and guided into the receiving chamber, the drinking straw including a first end having an inlet opening which projects towards a base of the receiving chamber, and with a second end having a drinking opening, and with a suction channel between the inlet opening and the drinking opening, and
an aroma reservoir connected with the drinking straw via an inflow channel,
wherein the aroma reservoir contains a liquid aroma medium which contains fragrances and/or flavorings in dissolved or emulsified and thus diluted form and which, when liquid is sucked from the drinking vessel through the drinking straw, is sucked through the inflow channel into the drinking straw and is mixed there with the liquid sucked into the drinking straw from the drinking vessel.

2. The drinking system according to claim 1, wherein the liquid aroma medium comprises fragrances or flavorings diluted in water at a ratio of 1:15 to 1:1,000.

3. The drinking system according to claim 1, wherein at least one sweetener is contained in dissolved form in the liquid aroma medium.

4. The drinking system according to claim 3, wherein at least one sweetener selected from the group consisting of stevia, aspartame and acesulfame is contained in dissolved form in the liquid aroma medium.

5. The drinking system according to claim 1, wherein the aroma reservoir comprises a container which is arranged or can be arranged on the drinking vessel, in which the liquid aroma medium is arranged.

6. The drinking system according to claim 5, wherein the container has a low height in relation to its base area, namely a ratio of height in mm to base area in mm2 of 1:50 or less.

7. The drinking system according to claim 5, wherein the container has a height which is at most 15% of a length of the drinking straw.

8. The drinking system according to claim 5, wherein the container has a supply air opening.

9. The drinking system according to claim 8, wherein the supply air opening has a diameter of 1.5 mm or less.

10. The drinking system according to claim 8, wherein the supply air opening can be closed with a lid when the drinking system is not being used.

11. The drinking system according to claim 5, wherein the container is closed with a lid which can be attached in a detachable manner.

12. The drinking system according to claim 1, wherein the inflow channel has a tube portion which dips into the liquid aroma medium from above and has an inflow opening.

13. The drinking system according to claim 1, wherein the inflow channel has an inner diameter of at most 1.5 mm.

14. The drinking system according to claim 1, further comprising a suction tube connected with the drinking straw to suck ambient air into the liquid flow sucked with the drinking straw.

15. The drinking system according to claim 14, wherein the suction tube is formed and dimensioned in relation to the other flow elements of the drinking system in such a way that, during suction, a volume flow of sucked air is generated which is between 5 and 10% of the liquid volume to be drunk.

16. The drinking system according to claim 6, wherein the container has a low height in relation to its base area of approximately 1:60.

17. The drinking system according to claim 7, wherein the container has a height of approximately 10% of the height of the drinking straw.

18. The drinking system according to claim 9, wherein the supply air opening has a diameter of 1 mm or less.

19. The drinking system according to claim 13, wherein the inflow channel has an inner diameter of approximately 1 mm.
